(19) United States
(12) Patent Application Publication
(10) Pub. No.: US 2025/0096338 A1
(43) Pub. Date: Mar. 20, 2025

(54) BATTERY SYSTEM AND METHOD FOR MONITORING A BATTERY SYSTEM

(71) Applicant: SAMSUNG SDI CO., LTD., Yongin-si (KR)

(72) Inventor: Eymen IPEK, Graz (AT)

(21) Appl. No.: 18/422,547

(22) Filed: Jan. 25, 2024

(30) Foreign Application Priority Data
Sep. 15, 2023 (EP) 23197715.8

(51) Int. Cl. H01M 10/48; G01B 7/16; H01M 10/44; H01M 10/613; H01M 50/204

(52) U.S. Cl. CPC H01M 10/48; G01B 7/16; H01M 10/445; H01M 10/613; H01M 50/204

(57) ABSTRACT

The present disclosure refers to a battery system (100), including a battery pack (10) including a housing (11) and a plurality of battery cells (12) accommodated within the housing (11); wherein the battery pack (10) includes a plurality of piezoelectric sensors (22, 24, 26, 28) attached to the housing (11) to detect a dimensional change of the housing (11) caused by an increased pressure inside of at least one of the battery cells (12) due to a degassing of the at least one of battery cell.

### CROSS-REFERENCE TO RELATED APPLICATION

The present application claims priority to and the benefit of European Patent Application Ser. No. 23/197,715.8, filed on Sep. 15, 2023, in the European Intellectual Property Office, the entire disclosure of which is incorporated herein by reference.

### BACKGROUND

### 1. Field

Aspects of embodiments of the present disclosure relate to a battery system and a method for monitoring such a battery system.

### 2. Description of the Related Art

Recently, vehicles for transportation of goods and people have been developed that use electric power as a source for motion. Such an electric vehicle is an automobile that is propelled by an electric motor using energy stored in rechargeable batteries. An electric vehicle may be powered solely by batteries or may be a hybrid vehicle powered by, for example, a gasoline generator or a hydrogen fuel cell. A hybrid vehicle may include a combination of an electric motor and a conventional combustion engine.

Generally, an electric-vehicle battery (EVB or traction battery) is a battery used to power the propulsion of battery electric vehicles (BEVs). Electric-vehicle batteries differ from starting, lighting, and ignition batteries in that they are designed to provide power over sustained periods of time.

A rechargeable (or secondary) battery differs from a primary (or non-rechargeable) battery in that it is designed to be repeatedly charged and discharged, while the latter is designed to provide only an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, a rechargeable (or secondary) battery cell includes an electrode assembly including a positive electrode, a negative electrode, and a separator interposed between the positive and negative electrodes, a case accommodating the electrode assembly, and an electrode terminal electrically connected to the electrode assembly. An electrolyte solution is injected into the case to enable charging and discharging of the battery cell via an electrochemical reaction between the positive electrode, the negative electrode, and the electrolyte solution. The shape of the case, such as a cylindrical or rectangular shape, may be selected based on the battery's intended purpose. Lithium-ion (and similar lithium polymer) batteries, widely known via their use in laptops and consumer electronics, are the dominant form of secondary batteries the most recent electric vehicles in development.

Rechargeable batteries may be used as a battery module including a plurality of unit battery cells coupled to each other in series and/or in parallel to provide high power density, such as for motor driving of a hybrid vehicle. For example, the battery module may be formed by interconnecting the electrode terminals of the plurality of unit battery cells in an arrangement or configuration depending on a desired amount of power and to provide a high-power rechargeable battery.

Battery modules can be constructed in either a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include of a plurality of battery modules connected together in series to provide a desired voltage. The battery modules may include submodules including a plurality of stacked battery cells (e.g., a battery stack or stack), and each stack includes cells connected together in parallel that are, in turn, connected in series (XpYs) or cells connected together in series that are, in turn, connected in parallel (XsYp).

A battery pack is a set of any number of (usually identical) battery modules. The battery modules may be connected in a series, parallel, or series/parallel connection configuration to provide a desired voltage, capacity, and/or power density. Components of a battery pack include the individual battery modules and the interconnects, which provide electrical conductivity between the battery modules.

Exothermic decomposition of cell components may lead to a so-called thermal runaway. Generally, thermal runaway describes or refers to a process that accelerates due to increased temperature, in turn releasing energy that further increases temperature. Thermal runaway occurs in situations when an increase in temperature changes the conditions in a way that causes a further increase in temperature, often leading to a destructive result.

In rechargeable battery systems, thermal runaway is associated with strong exothermic reactions that are accelerated by temperature rise. These exothermic reactions include combustion of flammable gas compositions within the battery pack housing. For example, when a cell is heated above a critical temperature (typically above about 150° C.) the battery cell can transition into a thermal runaway. The initial heating may be caused by a local failure, such as a battery cell internal short circuit, heating from a defective electrical contact, short circuiting to a neighboring battery cell, etc. During the thermal runaway, a failed battery cell, that is, a battery cell which has or is experiencing a local failure, may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is, therefore, flammable and potentially toxic. The vented gas also causes a gas-pressure to increase inside the battery pack.

According to the related art, a battery pack for a vehicle may include a battery pack body and multiple strain gauge sensors distributed on an inner surface of the upper casing of the battery pack to collect a deformation value of a battery pack shell. The deformation of the battery pack is monitored in real time, and the deformation of the shell is mapped to a pressure difference between the inside and outside of the battery pack. When a deformation amount is greater than a threshold value, a thermal runaway signal is generated.

According to the related art, a device for managing an accumulator may include at least three strain gauges arranged to measure stresses along at least three distinct stress axes, a measuring device to measure strains undergone by each gauge along its stress axis, a reversible electrical switch, a calculating device to control opening and closing of the electrical switch depending on measurements carried out by the measuring device.

Additionally, according to the related art, a battery pack may include a battery and a sensor configured to detect a state of the battery. The sensor may include an insulating layer and a resistor on one side of the insulating layer. The resistor may be formed of a chrome composite film. The sensor detects the state of the battery as a change in a resistance value of the resistor. The battery pack may also include a strain gauge that detects an expansion of the battery.

### SUMMARY

The present disclosure is defined by the appended claims and their equivalents. Any disclosure lying outside the scope of the claims is intended for illustrative as well as comparative purposes.

According to an embodiment of the present disclosure, a battery system includes: a battery pack including a housing, a plurality of battery cells accommodated within the housing, and a plurality of piezoelectric sensors attached to the housing and configured to detect a dimensional change of the housing caused by an increased pressure inside at least one of the battery cells.

According to another embodiment of the present disclosure, a method for monitoring a battery system is provided. The method includes: providing a battery system as described above; detecting a deformation of the housing caused by a pressure increase inside at least one of battery cells inside of the housing; and when the deformation of the housing exceeds a threshold value, initiating safety measures.

Further aspects and features of the present disclosure can be learned from the dependent claims and the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic view of battery system according to an embodiment of the present disclosure.

FIG. 2 is a schematic cross-sectional view of another embodiment of the present disclosure.

FIG. 3 is a schematic cross-sectional view of another embodiment of the present disclosure.

FIG. 4 is a schematic cross-sectional view of another embodiment of the present disclosure.

FIG. 5 is a sectional view of the battery system shown in FIG. 1 in normal use condition.

FIG. 6 is a sectional view of the battery system shown in FIG. 1 with a battery cell experiencing a thermal event; and

FIG. 7 is a flow chart describing a process for monitoring a battery system and detecting a thermal failure of a battery cell within a battery system according to an embodiment of the present disclosure.

### DETAILED DESCRIPTION

Reference will now be made, in detail, to embodiments, examples of which are illustrated in the accompanying drawings. Aspects and features of the described embodiments, and implementation methods thereof, will be described with reference to the accompanying drawings. The present disclosure, however, may be embodied in various different forms and should not be construed as being limited to the embodiments described herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although terms, such as “first” and “second,” are used to describe various elements, these elements should not be limited by these terms. These terms are only used to distinguish one element from another element.

For example, a first element may be named a second element and, similarly, a second element may be named a first element, without departing from the scope of the present disclosure. Expressions, such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system includes a battery pack including a housing and a plurality of battery cells accommodated within the housing, a plurality of piezoelectric sensors attached to the housing to detect a dimensional change of the housing caused by, for example, an increased pressure inside of at least one of the battery cells due to a degassing of the at least one battery cell.

For example, embodiments of the present disclosure provide a battery system including a housing and a plurality of battery cells arranged within the housing to form a battery pack. The battery system may further include a plurality of detectors including piezoelectric sensors arranged at the housing to detect deformation of the housing due to, for example, a malfunction of at least one battery cell in the housing.

According to the arrangement of the piezoelectric sensors on the housing, it is possible to detect a swelling of a battery cell due to a degassing of the electrolyte and an associated risk of thermal destruction in an early stage of the degassing process, before a serious fault occurs in the battery pack. In this way, the effects of a defective battery cell can be mitigated and, for example, a thermal runaway of the entire battery pack caused by a chain reaction can be prevented.

In a battery system, according to an embodiment, a first set of piezoelectric sensors is arranged on a first side of the housing and a second set of piezoelectric sensors is arranged on a second side of the housing facing away from the first side of the housing. By arranging the piezoelectric sensors on two different sides of the housing, deformation of the housing caused by, for example, a pressure increase in at least one of the battery cells can be detected. In addition, such an arrangement of pressure sensors is particularly simple and inexpensive because the sensors have to be arranged in the interior of the housing, such that the assembly effort and the assembly costs can be reduced.

The first set of piezoelectric sensors is arranged on an outside of the housing, and the second set of piezoelectric sensors is arranged on an inside of the housing. The arrangement of a first set of piezoelectric sensors on an outer wall of the housing and a second set of piezoelectric sensors on the inner wall of the housing enables detection of deformations in the corresponding housing wall. Thus, not only can the deformation of the housing be detected but also the stresses initiated by the deformation, tensile stresses, compressive stresses, or shear stresses, which are directly related to the pressure increase in the affected battery cell, can be detected.

According to another embodiment of the present disclosure, the first set of piezoelectric sensors is arranged on a first outside surface of the housing, and the second set of piezoelectric sensors is arranged on a second outside surface of the housing facing away from the first outside surface of the housing. By placing the first set of piezoelectric sensors and the second set of piezoelectric sensors on different outside surfaces of the housing, a simple and inexpensive arrangement to detect deformation of the housing caused by, for example, a pressure increase inside at least one battery cell is provided. The arrangement of the piezoelectric sensors on the outside surfaces of the housing also has the advantage that no cables or other connections need to be routed through the housing, thus avoiding the need for additional sealing of this feedthrough. This can ensure that there is no leakage due to additional openings in the housing and the potential risk of electrolyte leaking at such a feedthrough.

According to another embodiment of the battery system, the first set of piezoelectric sensors is arranged on a first inside surface of the housing, and the second set of piezoelectric sensors is arranged on a second inside surface of the housing facing towards the first inside surface of the housing. By arranging the piezoelectric sensors on the inside of the housing, the sensors can be well protected from mechanical damage, especially from damage caused by stones, dirt, or rolling grit that have been stirred up or from contamination by splash water. This can increase the reliability and service life of the piezoelectric sensors.

In an embodiment of the present disclosure, the battery system further includes a detector connected to the piezoelectric sensors and configured to detect a change in voltage, resistance, or current in the piezoelectric sensors caused by deformation of the housing. The detector evaluates the signals from the piezoelectric sensors in a simple manner so that deformation of the housing is detected. An evaluation unit and an algorithm stored in the evaluation unit can be used to detect (or determine) the area or the battery cell from which the deformation of the housing is triggered by outgassing and inflation of the battery cell concerned.

In another embodiment of the battery system, the piezoelectric sensors are configured to detect elongation of the housing. Depending on the arrangement or orientation of the battery cells in the housing, degassing of a battery cell can primarily cause a change in the length of the housing in the longitudinal direction or transverse direction. In addition, the circumference of the housing increases due to the increase in volume of the affected battery cell. Therefore, measuring a change in length may be suitable to detect outgassing of a battery cell. In an embodiment of the battery system, the piezoelectric sensors are configured to detect a change in longitudinal and/or transversal direction of the housing.

According to another embodiment of the battery system, the piezoelectric sensors are configured to detect shearing or shear stresses of the housing. Degassing of a battery cell can also lead to shear on the housing and resulting shear stresses. This shear or the shear stresses can also be used to detect a deformation of the housing due to the degassing of a battery cell.

In an embodiment of the present disclosure, the battery system further includes a time detector that is configured to evaluate a temporal change of the housing to detect a thermal runaway. By recording a change in the housing over time, whether the housing is deforming slowly as part of a permissible aging process or whether the housing is rapidly expanding due to, for example, the degassing of a battery cell and the associated rapid change in volume of the battery cell may be determined.

When a degassing of a battery cell begins, the internal pressure of a battery pack increases abruptly. This pressure increase creates forces and tension on the housing walls. The piezoelectric sensors can detect this abrupt change in dimension by measuring dimensional differences. Also, such abrupt change is quite different from dimensional changes due to cell swelling or aging of the battery cells. While the degassing process happens within minutes, the change of dimension due to swelling or ageing happens over relatively long time periods, such as weeks or months.

According to another embodiment of the present disclosure, a method for monitoring a battery system is provided. The method includes the steps of providing a battery system as described above; detecting a deformation of the housing caused by a pressure increase inside of at least one battery cell inside of the housing; and initiating safety measures when the deformation of the housing exceeds a threshold value.

The method allows for the detection of a thermal failure event of at least one battery cell of the battery system at an early stage so that safety measures can be taken to prevent further damage to the battery pack or the battery system.

According to an embodiment, the safety measures include shutdown of the affected battery cell or the battery pack. A shutdown of the affected battery cell or the entire battery pack can slow the degassing process and/or reduce heat generation in the affected battery cell, reducing the risk of spillover to adjacent battery cells. This can prevent a thermal runaway, that is, a chain reaction in which the entire battery pack is thermally destroyed.

In an embodiment, the safety measures include, alternatively or in addition to shutting down the affected battery cell or the battery pack, increased cooling of the affected battery cell, the battery pack, and/or the housing. The cooling of the affected battery cell can also be increased to slow the degassing process and remove as much heat as possible from the affected battery cell to prevent thermal spillover to adjacent battery cells.

In another embodiment of the present disclosure, the deformation of the housing is related to a time interval and detection of a critical event when the deformation of the housing per time interval exceeds a threshold value. By recording deformation or dimension change over time, whether the housing is deforming slowly as part of a permissible aging process or whether the housing is rapidly expanding due to the degassing of a battery cell and the associated rapid change in volume of the battery cell can be determined.

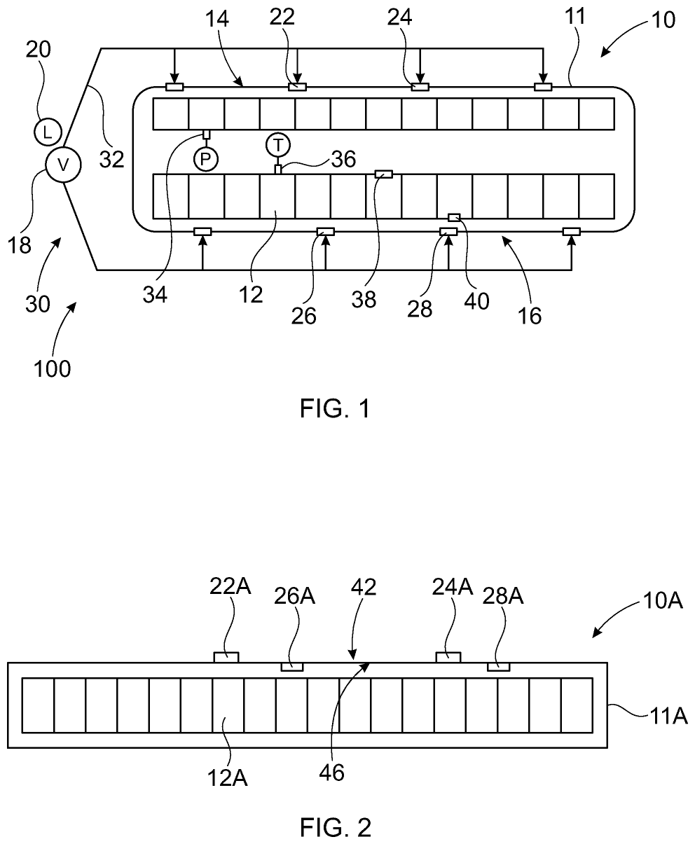

FIG. 1 is a schematic view illustrating a battery system 100 according to an embodiment of the present disclosure. The battery system 100 includes a battery pack 10 including a housing 11 and a plurality of battery cells 12 accommodated within the housing 11. The battery pack 10 further includes a plurality of piezoelectric sensors 22, 24, 26, 28 attached to the housing 11 to detect a dimensional change of the housing 11 caused by increased pressure inside at least one of the battery cells 12 due to a degassing of the battery cell 12.

The battery system 100 further includes a battery monitoring system 30 including a measuring circuit 32 and a detector 18 connected to the piezoelectric sensors 22, 24, 26, 28. The detector 18 is configured to detect a change in voltage, resistance, or current in the piezoelectric sensors 22, 24, 26, 28 caused by deformation of the housing 11. The battery system 100 includes a time detector 20 to detect a change in the expansion of the housing 11 over time. The battery system 100 may further include a pressure sensor 34 to detect a pressure within the battery pack 10 and/or a temperature sensor 36 to detect a temperature within the battery pack 10.

As shown in FIG. 1, a first set of piezoelectric sensors 22, 24 is arranged on a first side 14 of the housing 11, and a second set of piezoelectric sensors 26, 28 is arranged on a second side 16 of the housing 11 facing away from the first side of the housing 11. The battery cells 12 may include (e.g., may each include) a venting open (e.g., a venting valve) 38 and/or a pressure relief valve 40 to limit a pressure increase in the battery cells 12 and to prevent an uncontrolled leakage of electrolyte from the battery cells 12. For the sake of illustration, one venting open 38 and one pressure relief valve 40 are shown in FIG. 1, but each battery cell 12 may have at least one of the venting open 38 and the pressure relief valve 40.

FIG. 2 is a schematic cross-sectional view of another embodiment of the present disclosure. As shown in FIG. 2, a battery pack 10A includes a housing 11A, a first set of piezoelectric sensors 22A, 24A arranged on a first outside surface 42 of the housing 11, and a second set of piezoelectric sensors 26A, 28A arranged on a first inside surface 46 of the housing 11 facing towards the first outside surface 42 of the housing 11A. This arrangement of piezoelectric sensors 22A, 24A, 26A, 28A allows for very accurate monitoring of a housing wall of the housing 11 for an early detection of a change in dimension caused by a degassing of a battery cell 12A.

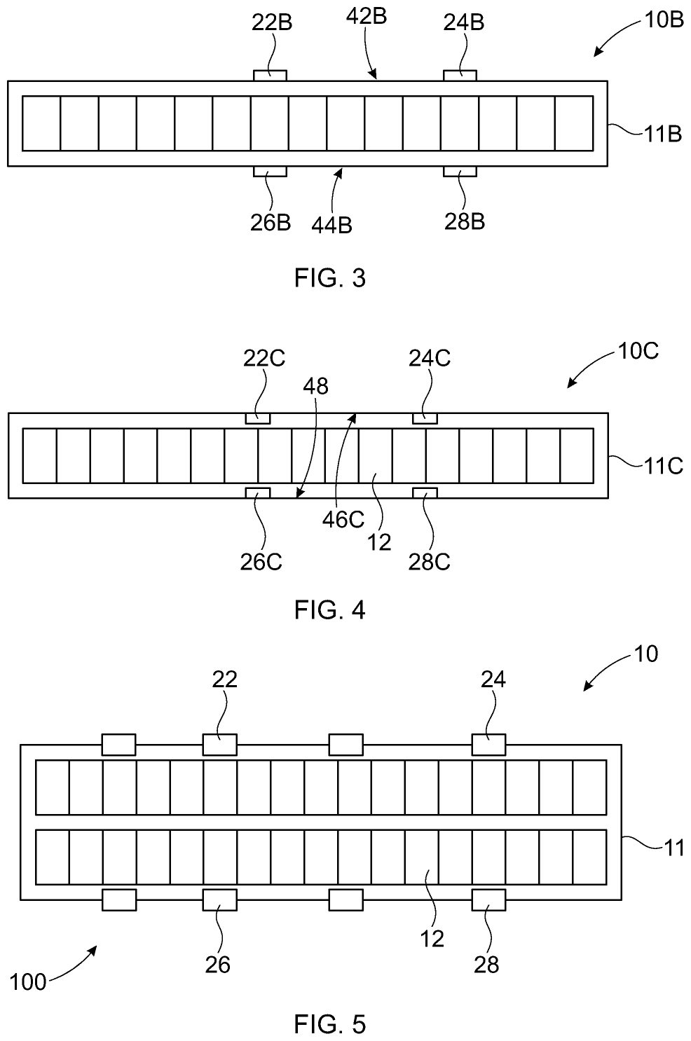

FIG. 3 is a schematic cross-sectional view of another embodiment of the present disclosure. As shown in FIG. 3, a battery pack 10B includes a housing 11B, a first set of piezoelectric sensors 22B, 24B arranged on a first outside surface 42B of the housing 11B, and a second set of piezoelectric sensors 26B, 28B arranged on second outside surface 44B of the housing 11B facing away from the first outside surface 42B of the housing 11. This arrangement of piezoelectric sensors 22B, 24B, 26B, 28B allows all of the piezoelectric sensors 22B, 24B, 26B, 28B to be outside of the housing 11B so there is no need for additional sealing of a feedthrough to connect to the piezoelectric sensor inside of the housing 11B.

FIG. 4 is a schematic cross-sectional view of another embodiment of the present disclosure. As shown in FIG. 4, a battery pack 10C includes a housing 11C, a first set of piezoelectric sensors 22C, 24C arranged on a first inside surface 46C of the housing 11C, and a second set of piezoelectric sensors 26C, 28C arranged on a second inside surface 48 of the housing 11C facing towards the first inside surface 46C of the housing 11C. By arranging the piezoelectric sensors 22C, 24C, 26C, 28C on the inside of the housing 11C, the piezoelectric sensors 22C, 24C, 26C, 28C can be protected from mechanical damage, from damage caused by stones, dirt, or rolling grit that have been stirred up, and from contamination by splash water, which can increase the reliability and lifespan of the piezoelectric sensors 220, 24C, 26C, 28C.

FIG. 5 shows the battery system 100 shown in FIG. 1 in normal use condition. In normal use condition, the housing 11 of the battery pack 10 is not affected by any thermal affect, and there is no critical deformation of the housing 11.

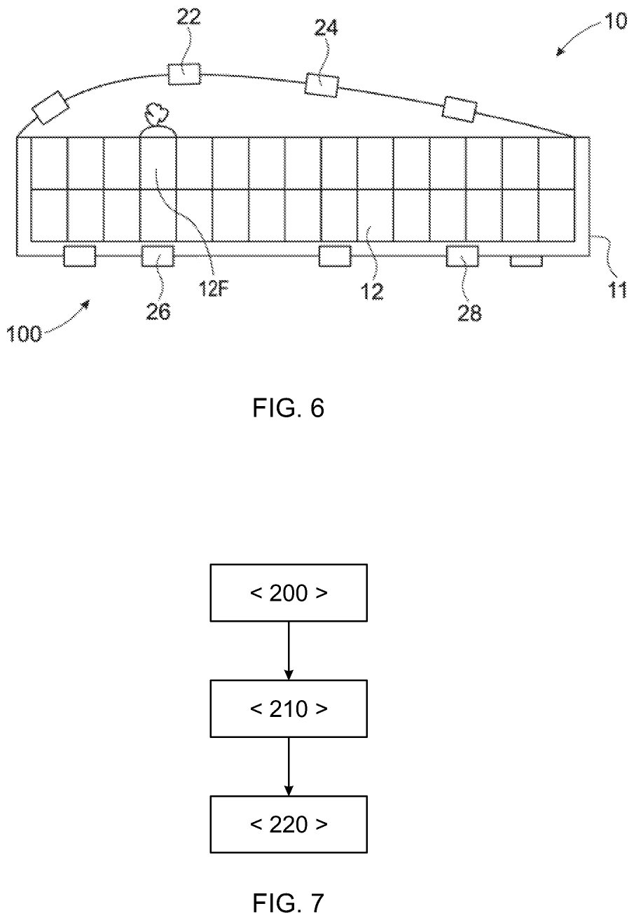

FIG. 6 shows the battery system 100 shown in FIG. 1 in which at least one of the battery cells 12F of the battery pack 10 is experiencing a thermal event. The degassing of the battery cell 12F deforms the housing 11 and increases its shape (or volume) due to the pressure increase inside the housing 11 such that a wall of the housing 11 has a convex shape. This swelling of the housing 11 can be detected by the piezoelectric sensors 22, 24 so that the thermal event in the battery cell 12F is detected in time, before this thermal event causes damage to neighboring battery cells 12.

The detection of deformation of the housing of the battery system by piezoelectric sensors can also be implemented in the other embodiments described above.

FIG. 7 is a flow chart describing steps of a process for monitoring a battery system and detecting a thermal failure of at least one of battery cells within the battery system according to an embodiment of the present disclosure. Describing the process using the battery system shown in FIG. 1 as an example, in a first step <200>, the battery system 100 is provided. In a second step <210>, deformation of the housing 11 is detected by the piezoelectric sensors 22, 24, 26, 28 caused by a pressure increase inside at least one of the battery cells 12F inside of the housing 11. In a third step <220>, safety measures are initiated when the deformation of the housing 11 exceeds a threshold value. The safety measures can include shutdown of the affected battery cell 12F, a battery stack, or the battery pack 10 and/or increased cooling of the affected battery cell 12F, the affected battery stack, or the battery pack 10 to slow the degassing process and/or reduce heat generation in the affected battery cell 12F, reducing the risk of spillover to adjacent battery cells 12. The safety measures can prevent a thermal runaway, that is, a chain reaction in which the entire battery pack 10 is thermally destroyed.

The method allows for detection a thermal failure event of at least one of the battery cells 12F of the battery system 100 at an early stage so that safety measures can be taken to prevent further damage to the battery pack 10 or the battery system 100. The pressure increase in the battery cell 12F creates forces and tension on the housing walls of the housing 11. The piezoelectric sensors 22, 24, 26, 28 can detect this abrupt change in dimension by measuring dimensional differences. Also, this abrupt dimensional change is quite different from allowable dimensional changes due to cell swelling or aging of the battery cells 12. While the degassing process happens within seconds or minutes, the change of dimension due to swelling or ageing happens within long time periods, such as weeks or months.

Some Reference Numerals

| | | | |
|---|---|---|---|
| 10 | battery pack | 11 | housing |
| 12 | battery cells | 12F | affected battery cell |
| 14 | first side | 16 | second side |
| 18 | detector | 20 | time detector |
| 22 | first piezoelectric sensor | 24 | second piezoelectric senor |
| 26 | third piezoelectric sensor | 28 | fourth piezoelectric sensor |
| 30 | battery monitoring system | 32 | measuring circuit |
| 34 | pressure sensor | 36 | temperature sensor |
| 38 | venting open | | |
| 40 | pressure relief valve | 42 | first outside surface |
| 44 | second outside surface | 46 | first inside surface |
| 48 | second inside surface | | |
| 100 | battery system | | |

What is claimed is:

1. A battery system comprising:
a battery pack comprising:
a housing; and
a plurality of battery cells accommodated within the housing; and
a plurality of piezoelectric sensors attached to the housing and configured to detect a dimensional change of the housing caused by increased pressure inside at least one of the battery cells.

2. The battery system according to claim 1, wherein a first set of the piezoelectric sensors is arranged on a first side of the housing, and
wherein a second set of the piezoelectric sensors is arranged on a second side of the housing facing away from the first side of the housing.

3. The battery system according to claim 2, wherein the first set of the piezoelectric sensors is arranged on an outside of the housing, and
wherein the second set of the piezoelectric sensors is arranged inside of the housing.

4. The battery system according to claim 2, wherein the first set of the piezoelectric sensors is arranged on a first outside surface of the housing, and
wherein the second set of the piezoelectric sensors is arranged on a second outside surface of the housing facing away from the first outside surface of the housing.

5. The battery system according to claim 2, wherein the first set of the piezoelectric sensors is arranged on a first inside surface of the housing, and
wherein the second set of the piezoelectric sensors is arranged on a second inside surface of the housing facing towards the first inside surface of the housing.

6. The battery system according to claim 1, further comprising a detector connected to the piezoelectric sensors and configured to detect a change in voltage, resistance, or current in the piezoelectric sensors caused by deformation of the housing.

7. The battery system according to claim 6, wherein the battery system further comprises a time detector,
wherein the detector and the time detector communicate with each other to detect a temporal change in the housing to detect a thermal runaway.

8. The battery system according to claim 1, wherein the piezoelectric sensors are configured to detect elongation of the housing.

9. The battery system according to claim 1, wherein the piezoelectric sensors are configured to detect a change in a longitudinal dimension or a transverse dimension of the housing.

10. The battery system according to claim 1, wherein the piezoelectric sensors are configured to detect shearing of the housing.

11. A method for monitoring a battery system, the method comprising:
providing the battery system according to claim 1;
detecting deformation of the housing caused by a pressure increase inside at least one of the battery cells inside of the housing; and
when the deformation of the housing exceeds a threshold value, initiating safety measures.

12. The method for monitoring a battery system according to claim 11, wherein the safety measures comprise a shutdown of the at least one of the battery cells or the battery pack.

13. The method for monitoring a battery system according to claim 11, wherein the safety measures comprise increased cooling of the least one of the battery cells and/or the housing.

14. The method for monitoring a battery system according to claim 11, wherein the deformation of the housing is measured over a time interval,
wherein, when the deformation of the housing per time interval exceeds a threshold value, a critical event is detected.
